(19) United States
(12) Patent Application Publication
(10) Pub. No.: US 2016/0300296 A1
(43) Pub. Date: Oct. 13, 2016

(54) System for the Online auctioning of preferential travel fares

(71) Applicant: INIGAL 11, S.L., Madrid (ES)

(72) Inventor: José Ignacio ALONSO CEMBRANO, Madrid (ES)

(21) Appl. No.: 14/392,080

(22) PCT Filed: Mar. 25, 2013
(86) PCT No.: PCT/ES2013/070194

§ 371 Date: Sep. 14, 2015

(51) Int. Cl. G06Q 30/08; H04L 29/08

(52) U.S. Cl. CPC G06Q 30/08; H04L 67/02; G06Q 50/30

(57) ABSTRACT

The invention relates to a system for the online auctioning of preferential travel fares, formed by: the information servers of different travel providers, the communication computer terminals of the corresponding passenger access control posts, and the mobile communication devices of passengers that paid non-preferential fares, such as smart phones, personal digital assistants or tablets, all interconnected via the Internet to a website hosted on an external HTTP or HTTPS server managed by an auctioning/bidding web application. The system is an effective means of selling the largest possible number of previously unsold business or first class tickets in the moments prior to the departure of an aircraft or transport vehicle, thereby increasing the profitability of each trip and allowing passengers with ordinary tickets to travel in business or first class for a lower fare.

Present invention is meant for a system for the online auctioning of preferential travel fares to be introduced in airlines and in passenger transport companies in general, as an effective means of selling, in hours or minutes prior to departure of an aircraft or whatever transport vehicle, the largest possible number of previously unsold business or first class tickets, thereby increasing the profitability of each trip and at the same allowing passengers with ordinary tickets to travel in business or first class for a lower fare.

This is a computer-implemented invention that for its put into practice requires the use of computers of reservation centers of different participating travel companies as information servers, of computers placed on access controls for passengers, and of mobile computer and telecommunication personal devices widely spread in the public, such as smartphones, electronic diaries or tablets, being all these devices connected via internet to a website hosted on an external server and managed by an web application specifically designed for running an auctioning system in a short time period.

Technical field of the invention is therefore computing physics, data processing systems for commercial purposes and, more specifically, commerce, shopping or e-commerce.

### PREVIOUS STATE OF THE ART

The introduction of electronic commerce, during the nineties of last century, gave rise to online auctioning systems managed by a computer, on which bidders offer goods, services and/or information as bidding objects, which are received on an entrance computer and subsequently disclosed through telecommunication channels to client's devices, who make bids that are sent to an assessing unit in same or other computer to determine the best bid for any object.

First of these online auctioning systems consisted of a main computer or server of the bidder that offers goods or services, which was connected through a LAN (Local Area Network) or WAN (Wide Area Network) network to a plurality of devices pertaining remote clients, being auctioning process functions implemented in a computer application on that main computer. One example of this previous state of the art is, among many others, the U.S. Pat. No. 5,835,896, which discloses a method and system for processing and transmitting electronic auction information.

Later, important novelties in these online auctioning systems were introduced in connection with mobile telephony, such as those claimed on the European patent with Spanish publication number ES2216984-T3 “Computer-aided auctioning method and auctioning system”, on which telecommunication channels through which information about bidding objects is transmitted from an entrance unit to client's mobile communication devices, and from these devices to an assessing unit comprise a GSM and/or UMTS mobile telephony network.

It has not been until the introduction of the internet as a global telecommunication network that online auctions have had a wide diffusion in the public, with some patented telematics auctioning systems, as for instance the European patent with Spanish publication number ES2177484-T1 “A system and method for implementing an auction on a computer network” or, recently, the Canadian patent CA2564102A1 relative to an online event ticket auction, designed for maximizing the incomes of events and spectacles, organized through a website.

Computer and telecommunications technology on which this system for online auctioning is based is known, as a sort of electronic auctioning through internet, as it consists of a computer system formed by computers working as information servers, internet receiving devices as means of communication, but it rationally uses the resources nowadays offered by internet and communication and computer mobile devices such as smartphones, tablets or PDAs, to solve a technical problem existing in some travels made on passengers transport sector, which is the lack of a suitable plan, with its corresponding computer tool, so that companies can efficiently sell, to passengers with economy tickets, remaining tickets for preferential or business seats during minutes prior to departure time, to increase the profitability of the trip.

This situation happens specifically in passenger aerial transport, formed by civil airlines. Due to the high prices of preferential seats and the need to maximize the incomes of each trip, which are caused by the high cost of fuel, decrease of prices of economy tickets, etc., and due to the organization of aerial trips, on which passengers must pass through a shipment control of the airline prior to gaining access to the aircraft, there appears a opportunity, which in fact is being used at present by some airlines, by which passengers with economy tickets can exchange them for remaining tickets on preferential and business seats at a lower price, paying the difference in the moment.

This exchanging operation must be obviously carried out few moments prior to boarding, once airlines know how many preferential tickets have not been previously sold, which is now easy thanks to mobile devices with computer and internet access functions widely known and used among passengers, which allow online shopping, being the most common use the case of smartphones.

At present, and due to this new technologic environment, many Airlines offer passengers the possibility of exchanging, in check-in counters or even in boarding desks, their economy tickets for remaining business or first-class tickets at a lower price, by its online purchase on airline's website, for which they have computer applications (Apps) specifically designed for tablets and smartphones that users have to download previously. This means an issue for users, who have to download and learn the usage of each airline's App, each one different from the others, what eventually means a low use of this system and, therefore, existence of unsold preferential tickets with an excessively high price on one side, and on the other, preferential tickets sold at lower prices than the ones that could have been paid with a better system.

Disclosed system for the online auctioning of preferential travel fares solves these issues, as it is based on a unique auctioning system, implemented on a computer system on which main computers of different bidder airlines interact via internet with airline's devices on check-in counters or boarding desks and with passenger's mobile devices through a website hosted on an external server and managed by an auctioning/bidding web application, which is the only tool that companies and passengers need to carry on the exchange during moments prior to departure time.

System is considered as inventive, because, apart from the fact that no similar system is known at the moment, a search carried out in worldwide databases looking for patents disclosing systems for online auctioning of travel fares/seats has only revealed an American patent, US2012046977-A1, about an automated ticket selling system having a maximum price setting, which is different form this invention.

### DETAILED DESCRIPTION OF THE INVENTION

Claimed system for the online auctioning of preferential travel fares needs, to be put into practice, the use of computers hosting information servers of different participating travel companies, identified as “travel bidding entities”, of communication and computer devices of the passengers, specifically those of travellers who bought economy tickets, and devices associated to companies or entities access controls of passengers to the vehicle.

Said computers hosting information servers of different participating travel companies run, as any computer of a reservation center, under some predetermined software of the Operative System, which supports in this case the databases of passengers-travels, being these databases created while different kinds of tickets are being booked and sold through different channels, specially via Internet, and therefore those computers also put at the disposal of the potential passengers a dynamic website on which tickets can be acquired via online.

System is essentially characterized because said computers hosting information servers of different participating travel companies and said devices of the passengers and of checkpoints are connected through internet to a website hosted on an external HTTP or HTTPS server managed by an auctioning/bidding web application specifically designed to run the created auctioning system and because, on a preferred embodiment of the invention, these devices can be mobile devices such as laptops, smartphones, tablets, netbooks, PDAs or electronic diaries, built over mobile software platforms with a suitable software to gain access to internet through same protocols than main computers.

The above mentioned auctioning/bidding web application is organized into three layers: web browser, dynamic search engine and database, of which web technology comprises: software media for a http, https or any other protocol from TCP/IP family for navigation on the internet, thanks to which communications between server computers and devices are established; managing software media to process contents in the form of www (World Wide Web) pages and to create “mailbox” registers by the bidding travel entity, to assign and to identify user codes and to create “offer” and “bid” registers for each auction; and auctioning-bidding software media to manage the auctioning via internet, specially to inform about the start of the auction, the stage and the end of the auction via email, to register and manage the bids and conditions sent by users, to register and validate offers sent by participating travel companies, to block the biddings once prefixed time ends, to define the winner bids among those received according to two auctioning values such as the amounts and the number of available seats, and to compile winner bids on the “mailbox” registers of users.

Being based on this computer and telecommunications system, the method for the online auctioning of preferential travel fares that awards system's functionality is run on following seven main steps:

(1) Connection of the participant bidder entity with the system via internet to the website run by the auctioning/bidding web application, and creation of a user's “mailbox” register through the inclusion on the “bidders” database of the name, email address and other identification data, as well as selection profiles of auctions different from the bid, and assignation of a user's code through that application;

(2) Access, during any subsequent moment, of the participant bidder entity to the “travels-passengers” database hosted on its computer server, i.e., to the main reserve computer of the travel provider, extraction of a file containing the bid and auctioning conditions of preferential travel fares, with the indication of at least a code and a date identifying the travel, number of available preferential tickets, minimum price of first ticket, length of the auction and email addresses and number of non-preferential tickets or reserves of the passengers of that travel or target passengers, and connection via internet to the website by the auctioning/bidding web application, on which, in order to authenticate it uses the previously assigned user code, registration on the bidding through a form, and validation of the bidding that fulfils the conditions;

(3) Processing of the received file containing bid and conditions by the auctioning/bidding web application, therefore creating an “offer” register on the “offers/bids” database, containing such register a link to the page assigned to the bidder travel provider, number and date of the travel and number of available seats and minimum price on different usual and previously determined currencies, and sending a message via email to travel provider and passengers addresses, such message containing a notice of auction opening and stipulated duration;

(4) Connection of the passengers via internet on their devices to the website run by the auctioning/bidding web application, through a link contained on received message or through corresponding internet HTTP or HTTPS address, display on the bidder travel provider webpage of the normalized bid, prices and available seats after the bids sent until that point, and registration through a form of a “bid” register on the offers-bids database for one or several preferential travel tickets, depending on that the previous reserve included one or several non-preferential travel tickets, through the indication of the booking code and one or many bidding prices, for the amount of entire sums on the fixed currency, being that amount greater than the minimum amount previously fixed;

(5) Blocking of the biddings by the auctioning/bidding web application and auction ending after previously stipulated auctioning time, sending a message via email to travel provider and passenger's addresses, such message containing a notice of the end of the auction, and gathering, on the bidder's “mailbox” register, the bids that cover the offered seats, ordered from maximum to minimum amount.

(6) Sending a message via email to the addresses associated with the booking codes of non-preferential tickets of winner passengers, such message containing the assigned preferential ticket and the final amount.

(7) Redirection of the end of the auction message from the bidder entity to its shipment control, therefore warning the issuance of new preferential tickets, connection via internet from this terminal to the “mailbox” register of the website run by the auctioning/bidding web application, verification of the booking code of non-preferential tickets of winner passengers and the bided amounts on the previously-fixed currency, and exchange of non-preferential tickets for preferential tickets previous payment of these amounts by credit card on the shipment control or by charge on the bank account of each passenger when bid is accepted.

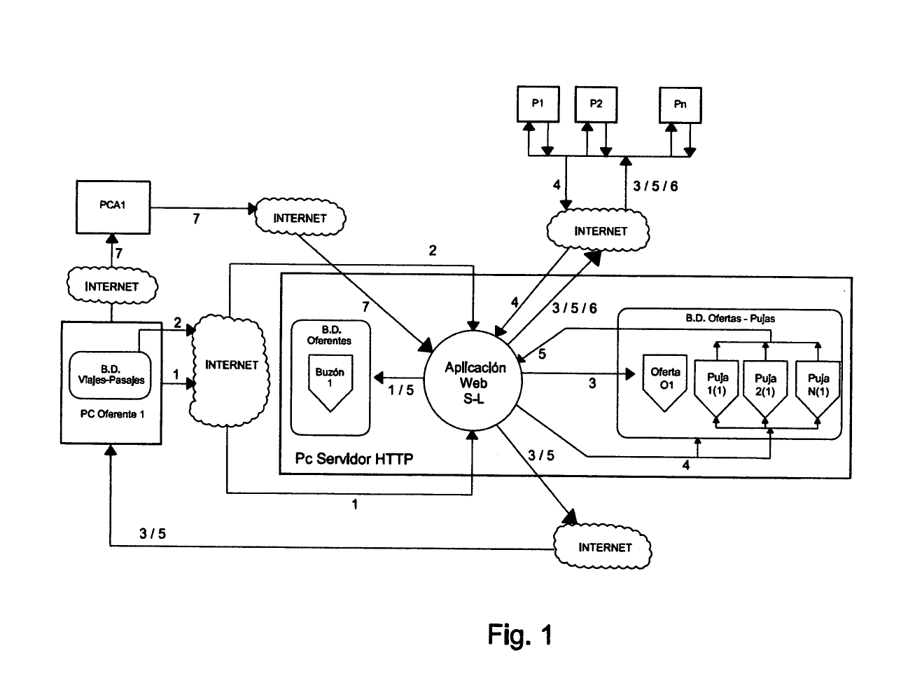

The diagram of FIG. 1 at the end of this document shows the interconnections and data flows produced among the elements that form the basic architecture of this system while it is running.

### PREFERRED EMBODIMENT OF THE INVENTION

As it was disclosed at the beginning of present application, the claimed online auctioning system is specially conceived for flight tickets and therefore the following preferred embodiment of the invention is based on a practice example of the operation of the system for airlines, bearing in mind the diagram showing interconnections and data flows of FIG. 1.

As a previous step, prior to start of system's operation, the airline, previously registered and identified in the system by means of the step described in (1), has been selling tickets for his flights via usual sales channels, and has stored on his database a list consisting of the data of his clients (name, address, email address, invoicing bank data, kind of booking), which are usually identified by an alphanumerical book code.

Once normal selling period is over, few hours before flight's boarding and departure, company knows exactly how many preferential seats have not been sold via usual sales channels and how many passengers have booked economy tickets, being these passengers the target passengers to whom the auctioning of remaining preferential tickets is assigned. Sid information is sent via internet (2) from the database hosted on the reservation center of the bidder airline to the website run by the auctioning/bidding web application and hosted on the server, also attaching other data such as identification of the flight which tickets are going to be auctioned, minimum price of first ticket and auction period.

The auctioning/bidding web application processes the information received, creating an “offer” register on the “offers-bids” database and sending via internet (3) as much to the bidder airline as to the target passengers an email on which auction start, its period, flight data and minimum bidding price on different and previously determined currencies are indicated.

Passengers receive the email on their devices, being these devices smartphones, PDAs, tablets or laptops, usually when they are in the airport or on their way to it, and can gain access to system's website to check the auction conditions and the bids' received at that point (users never see the names of the other passengers, just the amounts of the bids) and to start bidding for one or several available preferential travel seats of their previously booked flight. Said passengers send their bids via internet (4), being these bids registered on an “offers-bids” database hosted on the same server on which web application is hosted.

Bidding process is very easy: Users having economy tickets introduce, generally through an application on their smartphones, the flight number, date, name of the airline and name of the passenger. From that point, if the minimum offer is, for example, 1.000 $ for 10 available seats and first user bids 1.000 $, next user must bid for a greater amount (not decimal but complete amounts), i.e., the minimum would be 1.001 $ so that the last bidding user would have to offer at least 1.009 $. From that moment on, any additional bid would have to be for a different and greater amount from the previous ones, and would eliminate the lowest. Bids are not treated as “watermark”, it is to say, bids between higher and lower are admitted if intermediate amounts between them can be used in a bid.

In order to facilitate the auction, all passenger bid on the same currency, which is previously established by the airline and which will be used to collect the income. The application will show participants the bidding amounts in that currency and the exchange into another currency chosen by the user.

One the previously auctioning period ends, the application blocks the bids and ends the auction, warning that fact both to bidder entity and to passengers via email (5). Mailbox of bidder airline compiles the bids, organized according to their amount and indicating the seats that have been allocated by this auction.

Passengers who have won the auction will receive a new email (6) that informs them that they are beneficiaries of one or several preferential tickets and it also informs about the amount that is going to be charged on their current account or credit card due to these new tickets. The passenger does not have to do anything else, as the own bidding airline will exchange the tickets by redirecting (7) from its reservation center to its checkpoint in the airport, being this checkpoint the check-in desk or the boarding desk, the email previously received from the application warning about the end of the auction, and therefore the computer terminal of that checkpoint gains access to system's website to identify the winners (5), issuing the new preferential tickets for each winner passenger when he is at check-in desk or boarding desk.

1. System for the online auctioning of preferential travel fares, related to auctions assisted by computers and to the usage of communication networks, through which bidders offer goods and/or services as auction objects for which potential clients make bids that are assessed to determine the best bid, that for its put into practice requires in this case the usage of computers hosting information servers of different participating travel companies, which host travels/passengers databases and run under some predetermined software of the Operative System, database, browser and internet security manager, of a plurality of communication and computer devices of passengers who bought economy tickets, including mobile devices such as laptops, smartphones, tablets, netbooks, PDAs or electronic diaries, and of communication and computer devices associated to access controls of passengers to the travel vehicles of the different bidder entities, where said computers hosting information servers of different participating travel companies and said communication and computer devices of passengers and checkpoints are connected via Internet to a website hosted on an external HTTP or HTTPS server managed by an auctioning/bidding web application, characterized in that the auctioning/bidding web application which is organized into three layers web browser, dynamic search engine and database, is equipped with a web technology that comprises: software media for a http, https or any other protocol from TCP/IP family for navigation on the internet, thanks to which communications between server computers and devices are established; managing software media to process contents in the form of www (World Wide Web) pages and to create “mailbox” registers by the bidding travel entity, to assign and to identify user codes and to create “offer” and “bid” registers for each auction; and auctioning-bidding software media to manage the auctioning via internet, specially to inform about the start of the auction, the stage and the end of the auction via email, to register and manage the bids and conditions sent by users, to register and validate offers sent by participating travel companies, to block the biddings once prefixed time ends, to define the winner bids among those received according to two auctioning values such as the amounts and the number of available seats, and to compile winner bids on the “mailbox” registers of users.

2. System for the online auctioning of preferential travel fares, on the basis of the computer and telecommunications system disclosed on previous claims, which comprises following steps:
(1) Connection of the participant bidder entity with the system via internet to the website run by the auctioning/bidding web application, and creation of a user's “mailbox” register through the inclusion on the “bidders” database of the name, email address and other identification data, as well as selection profiles of auctions different from the bid, and assignation of a user's code through that application;
(2) Access, during any subsequent moment, of the participant bidder entity to the “travels-passengers” database hosted on its computer server, i.e., to the main reserve computer of the travel provider, extraction of a file containing the bid and auctioning conditions of preferential travel fares, with the indication of at least a code and a date identifying the travel, number of available preferential tickets, minimum price of first ticket, length of the auction and email addresses and number of non-preferential tickets or reserves of the passengers of that travel or target passengers, and connection via internet to the website by the auctioning/bidding web application, on which, in order to authenticate it uses the previously assigned user code, registration on the bidding through a form, and validation of the bidding that fulfils the conditions;
(3) Processing of the received file containing bid and conditions by the auctioning/bidding web application, therefore creating a “bid” register on the “offers/bids” database, containing such register a link to the page assigned to the bidder travel provider, number and date of the travel and number of available seats and minimum price on different usual and previously determined currencies, and sending a message via email to travel provider and passengers addresses, such message containing a notice of auction opening and stipulated duration;
(4) Connection of the passengers via internet on their devices to the website run by the auctioning/bidding web application, through a link contained on received message or through corresponding internet HTTP or HTTPS address, display on the bidder travel provider webpage of the normalized bid, prices and available seats after the bids sent until that point, and registration through a form of a “bid” register on the offers-bids database for one or several preferential travel tickets, depending on that the previous reserve included one or several non-preferential travel tickets, through the indication of the booking code and one or many bidding prices, for the amount of entire sums on the fixed currency, being that amount greater than the minimum amount previously fixed;
(5) Blocking of the biddings by the auctioning/bidding web application and auction ending after previously stipulated auctioning time, sending a message via email to travel provider and passenger's addresses, such message containing a notice of the end of the auction, and gathering, on the bidder's “mailbox” register, the bids that cover the offered seats, ordered from maximum to minimum amount.
(6) Sending a message via email to the addresses associated with the booking codes of non-preferential tickets of winner passengers, such message containing the assigned preferential ticket and the final amount.
(7) Redirection of the end of the auction message from the bidder entity to its shipment control, therefore warning the issuance of new preferential tickets, connection via internet from this terminal to the “mailbox” register of the website run by the auctioning/bidding web application, verification of the booking code of non-preferential tickets of winner passengers and the bided amounts on the previously-fixed currency, and exchange of non-preferential tickets for preferential tickets previous payment of these amounts by credit card on the shipment control or by charge on the bank account of each passenger when bid is accepted.
